(19) United States
(12) Patent Application Publication
(10) Pub. No.: US 2006/0136314 A1
(43) Pub. Date: Jun. 22, 2006

(54) Web-based automated code delivery

(75) Inventor: Michael P. Simon, Hemet, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Payment Protection Systems, Inc., Temecula, CA (US)

(21) Appl. No.: 11/205,999

(22) Filed: Aug. 18, 2005

Related U.S. Application Data
(60) Provisional application No. 60/605,531, filed on Aug. 31, 2004.

(51) Int. Cl. G06Q 40/00

(52) U.S. Cl. 705/35; 705/38; 705/43

(57) ABSTRACT

A method for preventing disablement of a device includes assigning a contract identification code, receiving a loan payment, forwarding the loan payment from a payment center to a finance company having an interest in the device, a code delivery computer determining whether the finance company has received the payment, the code delivery computer determining a previous code released for the device, releasing a new code subsequent to the previous code released for the device if the code delivery computer determines that the finance company has received the payment, the code delivery computer receiving the associated contract identification code from a user via telephony or an internet link, the code delivery computer providing the new code directly to the user via telephony, an internet link, or an email, and the device receiving the code from the user, thereby preventing disablement of the device.

### RELATED APPLICATIONS

This application claims priority to U.S. Provisional Application No. 60/605,531 which was filed in the U.S. Patent and Trademark Office on 31 Aug. 2004. The disclosures of U.S. Provisional Application No. 60/605,531, U.S. patent application Ser. No. 09/954,182, U.S. Provisional Application No. 60/236,392, and U.S. Provisional Application No. 60/288,794 are expressly incorporated herein by reference.

### BACKGROUND

The present invention is related to systems and methods for receipt of payment and delivery of codes for a system which disables equipment in response to the failure of a user to enter a code that corresponds with a stored code in the vehicle.

Typically, monthly payments to utility companies are made with very high reliability. This is partly due to the threat of service cut-off. For example, failure to pay a telephone bill will result in loss of telephone services. Thus, telephone bills are paid regularly because failure to do so has immediate and tangible results. Monthly payments on an automobile loan, for example, are not as likely to be paid regularly. Although an automobile may be repossessed, the process is expensive and complex. Thus, the threat of repossession is less immediate than telephone service cut-off. To encourage reliable loan re-payments, it is desirable to have a “service” cut-off for equipment subject to the loan, such as an automobile.

Conventional systems to encourage reliable loan re-payments interrupt the ignition system of an automobile on a regular, timed interval. To re-enable the automobile, a user is required to return to a payment center, make a payment, and have an agent reset the interrupt mechanism for a renewed timed interval. The system can only be reset by an authorized agent as it requires a key held in escrow at the payment center. While such a system is effective in encouraging users to repay their loans in a timely fashion, it has extreme overhead considerations. For example, the system requires a user to travel to the payment center each payment period of the loan in order to re-enable the automobile. In addition, a user must arrive at the payment center during its customer service hours. Still further, a user may have to wait to receive the attention of the first available agent at the payment center.

One solution to these problems is described in U.S. Pat. No. 6,195,648, entitled “Loan Repay Enforcement System” issued on Feb. 27, 2001 and U.S. patent application Ser. No. 09/397,132, entitled “Time Based Disablement of Equipment” filed on Sep. 16, 1999, both of which are herein expressly incorporated in their entirety by reference. This patent and application describe systems and methods for disabling equipment if a payment is not timely made. Specifically, a control module associated with the equipment stores a plurality of codes. In order to prevent disablement of the equipment, a code which corresponds to one of the stored plurality of codes must be entered prior to the expiration of a payment period. In order to receive a code, timely payment must be received and logged in a payment center.

These applications describe an exemplary embodiment where a user mails a payment to a payment center in advance of the deadline. When enough time has passed for the center to have received and processed the payment, the user can contact the payment center by means of a telephone to identify the loan. In response, an employee of the payment center can check the payment center's database and verify receipt of the payment. After verification, the employee of the payment center will disclose to the user the code which prevents disablement of the equipment. Since these systems rely upon the mailing of and processing of payments by a payment center, there can be a delay between the time payment is sent and a user is provided with a corresponding code. During this delay, the equipment may become disabled because a code had not been entered prior to the expiration of the payment period.

Typically, these payment centers are associated with the finance company which provide the financing for the purchase of the equipment. As the number of loans which use the systems described in these applications grows, there is an increased administrative burden on the finance company to manage the codes and the associated payments. For example, assume that a finance company finances 400 to 1000 loans a month which use the above-described disablement equipment. Further assume that each customer receives 36 codes for a three year loan. In less than one year the finance company would be responsible for between 500,000 and 1,000,000 codes.

Accordingly, it would be desirable to provide methods and apparatus which can reduce the delay between when a payment is made and a code is delivered. Further, it would be desirable to reduce the burden on finance companies for handling the codes.

### SUMMARY

The present invention addresses the above-identified and other deficiencies of prior systems by providing methods and apparatus for an automated code delivery system. In accordance with the present invention, a user can pay for and request one or more codes from a bank, an automated teller machine, a convenience store, grocery store or a check cashing store, all of which can be referred to as convenient payment receiving centers. A device at a convenient payment receiving center will interact with the finance company to forward a payment for financed goods. The finance company can then provide an indication to an automated code delivery computer that one or more payments have been received. The automated code delivery computer then can provide one or more codes to the user at the convenient payment receiving center. By using the present invention, payments for financed purchases can be made in a shorter period of time than the normal method of sending payments by mail. Further, after the payment is made, the user can almost instantaneously receive a code which prevents disablement of the user's vehicle. In accordance with one embodiment of the present invention, a code is requested from a finance company. The finance company determines whether payment has been received for a code. If payment has been received, the previous code released to the user is determined. Next it is determined whether more than one payment has been received. If only one payment has been received, a code which is subsequent to the previously released code is provided. Alternatively, if payment for more than one code has been received, then the number of codes subsequent to the previously released code is provided based upon the number of payments received. After receiving a code, the code can be entered into a time-based vehicle disablement device to prevent the disablement of a vehicle which has the time-based disablement device installed.

An exemplary method for obtaining a code and preventing disablement of a device includes assigning a contract identification code associated with a loan contract, a payment center receiving a loan payment, forwarding the payment from the payment center to a finance company, wherein the finance company has an interest in the device, a code delivery computer determining whether the finance company has received the payment, the code delivery computer determining a previous code released for the device, releasing a new code subsequent to the previous code released for the device if the code delivery computer determines that the finance company has received the payment, the code delivery computer receiving the associated contract identification code from a user via telephony or an internet link, the code delivery computer providing the new code directly to the user via telephony, an internet link, or an email, and the device receiving the code from the user, thereby preventing disablement of the device.

### BRIEF DESCRIPTION OF THE DRAWINGS

These and other features, aspects, and advantages of the present invention will become better understood with regard to the following description, appended claims and drawings where:

FIG. 1 illustrates an arrangement of elements in an exemplary system of the present invention;

FIG. 2 illustrates an exemplary method for an automated code delivery computer in accordance with the present invention;

FIG. 3 illustrates an exemplary method for a convenient payment receiving center in accordance with the present invention;

FIG. 4 illustrates an exemplary method for a finance company in accordance with exemplary embodiments of the present invention;

FIG. 5 illustrates an exemplary automated code delivery computer in accordance with exemplary embodiments of the present invention;

FIG. 6 illustrates an exemplary web page for receiving a contract ID code via a web interface; and

FIG. 7 illustrates providing access to the released codes via the web interface.

### DETAILED DESCRIPTION

In accordance with each of the exemplary embodiments of the invention, there is provided apparatus for and methods of delivery of codes and payments for a time-based disablement of equipment system. It will be appreciated that each of the embodiments described include both an apparatus and a method and that the apparatus and method of one exemplary embodiment may be different than the apparatus and method of another exemplary embodiment.

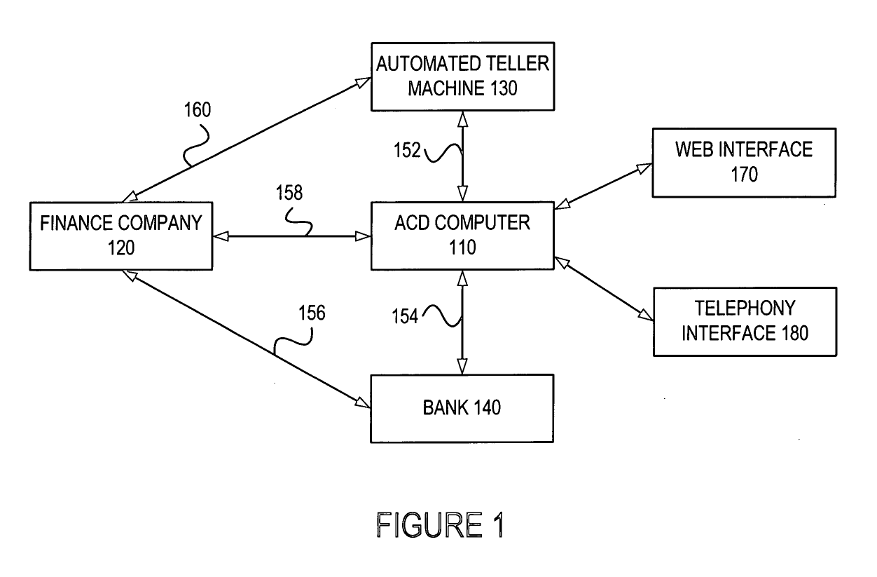

FIG. 1 illustrates an exemplary system for implementing the present invention. The system illustrated in FIG. 1 includes automated code delivery computer 110, finance company 120, automated teller machine 130, bank 140 and bi-directional communication links 152 through 160. In accordance with exemplary embodiments of the present invention, a user who wishes to receive a code or provide a payment would use either automated teller machine 130 or bank 140. If a user of automated teller machine 130 wished to provide a payment, the automated teller machine 130 provides the payment over bidirectional communication link 160 to finance company 120. Similarly, if a user at a bank 140 wished to make a payment, the bank would transmit the payment over bidirectional communication link 156 to finance company 120. It will be recognized that automated teller machine 130 and bank 140, can establish electronic payments with finance company 120, such that when a payment is made at either the automated teller machine 130 or bank 140, the payment is immediately provided to finance company 120.

Upon receipt of payment from automated teller machine 130 or bank 140, finance company 120 provides an indication over bidirectional communication link 158 to automated code delivery computer 110 that a payment has been made. If more than one payment is made, the finance company 120 would indicate that more than one payment has been made.

If a user at automated teller machine 130 desired to receive a code after making a payment, automated teller machine 130 would contact automated code delivery computer 110 via communication link 152. If automated code delivery computer 110 has received an indication from finance company 120 that payment has been made for a code which has not been released to the user, the automated code delivery computer 110 would provide automated teller machine 130 with the code or codes which have not been previously released to the user over bidirectional communication link 152. Similarly, if a user at bank 140 wishes to receive a code which the user had previously paid for, bank 140 would contact the automated code delivery computer 110 via bidirectional communication link 154. Again, if automated code delivery computer 110 has received an indication from finance company 158 of receipt of a payment associated with a code not previously released to the user, automated code delivery computer 110 would provide the code or codes over bidirectional communication link 154 to bank 140. It should be recognized that automated teller machine 130 and bank 140 are just two examples of the types of places in which payments may be made and codes received by a user. However, these may be replaced by any other place or apparatus in which payment can be made and transferred to the finance company and codes can be received by the automated code delivery computer. For example, these types of places include convenience stores, grocery stores and check cashing stores, and will be referred to herein as a convenient payment receiving center.

In an exemplary embodiment, users can request to receive codes at locations or via methods of their choosing. For example, a user can request to receive codes via an Internet connection between the user and the ACD computer 110, for example via a web interface module 170, and/or can request to receive the codes via telephony, for example via a telephony interface module 180 as shown in FIG. 1. The web interface module 170 can, for example, include a web page on the Internet, hosted for example by the ACD computer 110 or by a system in communication with the ACD computer 110, so that a user can visit the web page via an Internet browser and communicate with the ACD computer 110 via the web page. Both the web interface module 170 and telephony interface module 180 can be connected to the automated code delivery computer using appropriate connections. For example, after the automated code delivery computer 110 has received an indication from finance company 120 that payment has been made for a code which has not been released to the user, the automated code delivery computer 110 can provide a user with access to the code or codes which have not been previously released using a web browser via the web interface 170. A user can navigate to a specified webpage via a secure connection (such as an HTTPS connection). The user's request for delivery of the code(s) can be made via one or more of an Internet link, telephony, email, or any other method, for example via the ATM 130 or the bank 140, and can specify that the code(s) be delivered via one or more of an Internet link, telephony, email, or any other method, including for example via the ATM 130 or the bank 140. The request can be made at any time, including when the loan contract was entered into, and can include an email address to which the user desires code and/or related information to be sent.

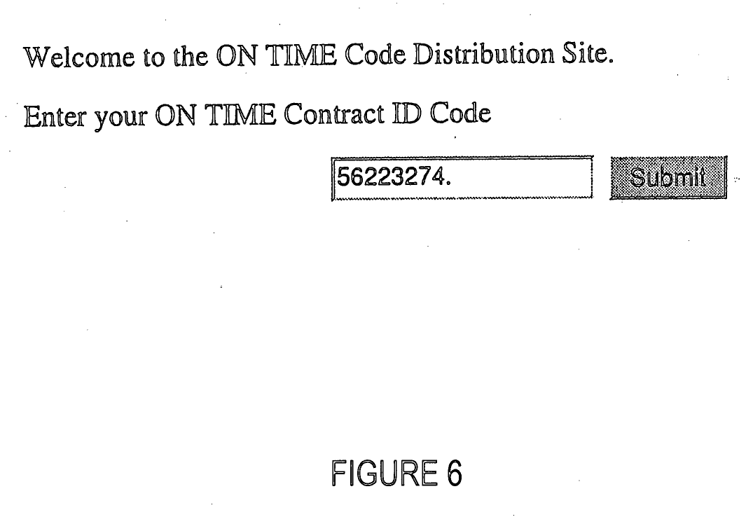

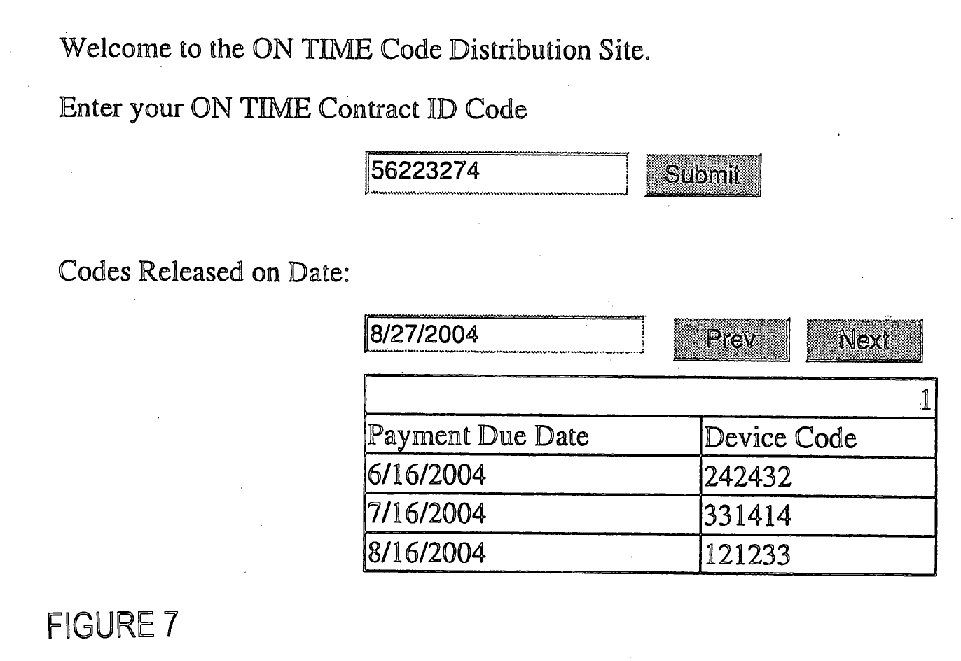

The web page can include information such as that shown in FIG. 6. To access the newly released codes, the user can enter information to associate or identify the user with the newly released codes. For example, the user can enter a contract ID code that is associated with the user's loan contract. The automated code delivery computer 110 can associate the user's loan contract ID code with released codes when it receives an indication from finance company 120 that payment for the corresponding codes has been made. Consider an example as shown in FIG. 6, where the associated contract ID code is 56223274. The user would be informed of this contract ID code, for example at the time the loan to secure the collateral is made. The user can enter this code in the appropriate field on a user interface of web interface 170. After the user enters the contract ID code into the web interface 170, the automated code delivery computer 110 determines whether the contract ID code corresponds to any released codes. If released codes are found to be associated with the entered contract ID code, the codes can be displayed on a second web page of the interface 107 as shown in FIG. 7. If the amount that the user has paid to the finance company 120 warrants the release of more than one code, each of the codes and corresponding due date can be displayed on the second web page as shown.

Instead of, or in addition to, displaying the released codes on a second web page of the interface 170 after a valid contract ID code is entered, the automated code delivery computer 110 can be configured to send an electronic mail message (or email message) to the user including any released codes associated with the valid contract ID code. The user can either enter an email address in an appropriate field of the web interface 170 (not shown), or can specify an email address where correspondence is to sent at the time loan contract is entered, or at any other time. In an exemplary embodiment, the user can submit a request for released codes in the form of an email, containing for example a valid contract ID code and/or other information identifying and verifying the contract and/or the user. The email request can include, for example, an indication or selection by the user, as to how the codes should be conveyed, for example by one or more of return email, telephone call (e.g. to a specific telephone number), publication on a website, and so forth.

In an exemplary embodiment, the user can initiate communication with the automated code delivery computer 110 using a telephone via the telephony interface 180, for example in a situation where the user cannot access or use the web interface 170. As will be understood by those skilled in the art, the telephony interface can include a wireless transceiver capable of communicating with portable telephones and other wireless communication devices, such as a PDA. When communication is established with the automated code delivery computer 110 via the telephony interface, the user can enter the appropriate contract ID code, e.g., 56223274, by any appropriate means, such as keying in the code using the telephone's keypad or speaking the code into the telephone.

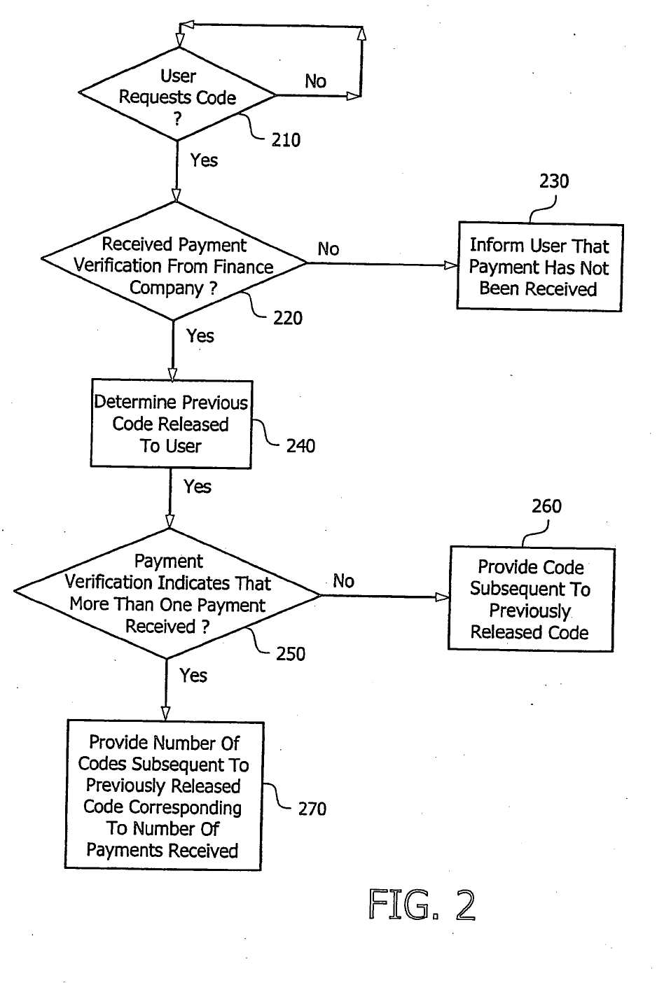

FIG. 2 illustrates an exemplary method performed by the automated code delivery computer. Initially, the automated code delivery computer determines whether it has received a request from a user for a code (step 210). The request from the user will be received by the automated code delivery computer from a convenient payment receiving center, the web interface 170, or perhaps the telephony interface 180. If the automated code delivery computer has not received a request for a code (“NO” path out of decision step 210), then the automated code delivery computer continues to wait for a user request. If, however, the automated code delivery computer has received a user request for a code (“YES” path out of decision step 210), then it is determined whether the automated code delivery computer has received payment verification from the finance company (step 220). If the automated code delivery computer has not received payment verification from the finance company (“NO” path out of decision step 220), then the automated code delivery computer informs the user that payment has not been received (step 230). More specifically, the automated code delivery computer can inform the convenient payment receiving center, which in turn, informs the user, an appropriate message can be displayed to the user via the web interface 170, or a recorded message can be delivered to a user's telephone via the telephony interface.

If it is determined that the automated code delivery computer has received payment verification from the finance company (“YES” path out of decision step 220), then the previous code released to the user by the automated code delivery computer is determined (step 240). Next the automated code delivery computer determines whether the payment verification indicates that more than one payment has been received (step 250). If the automated code delivery computer determines that more than one payment has not been received (“NO” path out of decision step 250), then the automated code delivery computer provides the code subsequent to the previously released code to the user (step 260). More specifically, the automated code delivery computer provides the code to the convenient payment receiving center which provides the code to the user, and/or the released codes are provided to the user via the web interface 170 or telephony interface 180. If, however, the automated code delivery computer determines that the payment verification indicates that more than one payment has been received (“YES” path out of decision step 250), then the automated code delivery computer provides the number of codes subsequent to the previously released code corresponding to the number of payments received by the finance company (step 270), see, e.g., FIG. 7 showing the release of three codes. As described herein, the codes can be provided to the user via a web interface such as the web interface 170, via telephony such as the telephony interface 180, and/or via email.

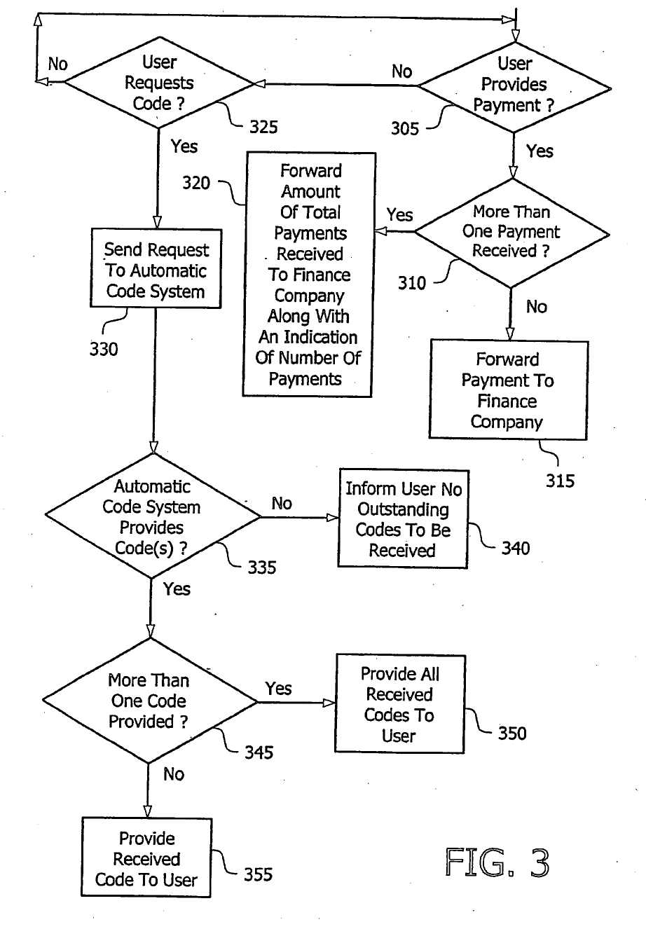

FIG. 3 illustrates an exemplary method performed by a convenient payment receiving center in accordance with the present invention. Initially, a convenient payment receiving center determines whether the user is providing payment (step 305). If the user is providing payment (“YES” path out of decision step 305), then the convenient payment receiving center determines whether it has received more than one payment (step 310). If the convenient payment receiving center determines that it has not received more than one payment (“NO” path out of decision step 310), then the convenient payment receiving center will forward the payment to the finance company (step 315). If, however, the convenient payment receiving center determines that more than one payment has been received (“YES” path out of decision step 310), the convenient payment receiving center will forward the amount of the total payments received to the finance company along with an indication of the number of payments being transmitted (step 320).

If the convenient payment receiving center determines that the user is not providing payment (“NO” path out of decision step 305), then the convenient payment receiving center determines whether the user is requesting a code (step 325). If it is determined that the user is not requesting a code (“NO” path out of decision step 325), then the convenient payment receiving center returns to determine whether the user is providing payment (step 305). If the convenient payment receiving center determines that the user is requesting a code (“YES” path out of decision step 325), then the convenient payment receiving center sends a request for codes to the automated code delivery computer (step 330).

Next the convenient payment receiving center determines whether the automated code delivery computer has provided a code (step 335). If it is determined that the automated code delivery computer has not provided a code (“NO” path out of decision step 335), then the convenient payment receiving center informs the user that there are no outstanding codes to be received (step 340). If, however, the automated code delivery has provided at least one code (“YES” path out of decision step 335), then it is determined whether more than one code has been provided (step 345). If it is determined that more than one code has been provided (“YES” path out of decision step 345), then the convenient payment receiving center provides all the received codes to the user (step 350). If, however, more than one code has not been provided (“NO” path out of decision step 345), then the received code is provided to the user (step 355).

Although not illustrated in FIG. 3, the methods described above can also include the steps of: the user inputting the code into a time-based equipment disablement device; the time based disablement device comparing the code received from the user with codes stored in memory; and if there is a match, storing an indication in the time-based disablement device that the code has been entered, thereby allowing the user to operate the equipment associated with the time-based disablement device until the date and/or time associated with a code which has not been entered has occurred. In addition, the methods can include the steps of: determining whether a date and/or time has occurred; if the date and/or time has occurred, determining whether a code associated with the date and/or time has been input into the time-based equipment disablement device; disabling the equipment if the code has not been previously entered; and allowing the equipment to operate if the code has been previously entered. Further, the disablement device can include a plurality of lights, e.g., light emitting diodes, to indicate if the end of a payment period is upcoming. For example, a green light would indicate that no payment is due, a yellow light would indicate that a payment is due shortly, and a red light would indicate that a payment is due immediately or the equipment will be disabled. Further, the lights can blink at an increasing frequency the closer in time it is to a payment due deadline.

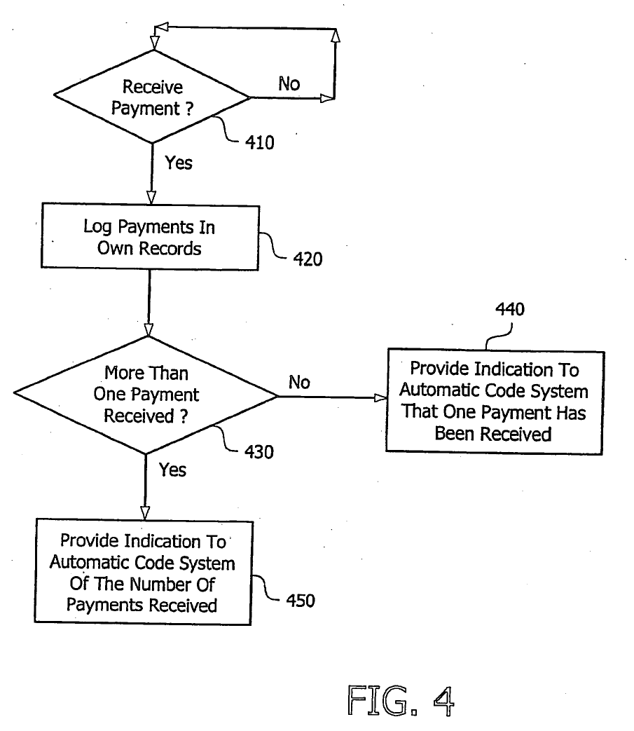

FIG. 4 illustrates an exemplary method performed by the finance company in accordance with the present invention. Initially, the finance company determines whether it has received a payment (step 410). If the finance company has not received a payment (“NO” path out of decision step 410), then the finance company continues to determine whether it has received a payment. If, however, the finance company has received a payment (“YES” path out of decision step 410), then the finance company logs the payment in their own records (step 420). Next, it is determined whether more than one payment has been received (step 430). If not more than one payment has been received (“NO” path out of decision step 430), then the finance company provides an indication to the automated code delivery computer 110 that one payment has been received (step 440). If more than one payment has been received (“YES” path out of decision step 430), then the finance company provides an indication to the automated code delivery computer 110 of the number of payments received (step 450).

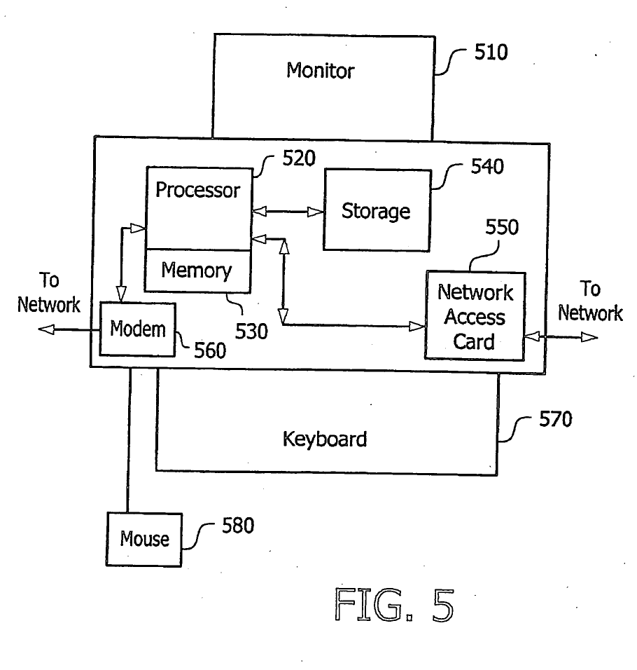

FIG. 5 illustrates an exemplary automated code delivery computer in accordance with the present invention. The automated code delivery computer includes a monitor 510, processor 520, memory 530, storage device 540, network access card 550, modem 560, keyboard 570 and mouse 580. The computer communicates with the finance company and the convenient payment receiving center either via modem 560 or using network access card 550. The computer communicates using modem 560 if the computer is connected to the finance company or the convenient payment receiving center via a public switched telephone network (PSTN), an integrated services digital network (ISDN), a coaxial cable or the like. The computer communicates using network access card 550 if the computer is connected to the finance company or the convenient payment receiving center via a wide area network (WAN), a local area network (LAN) or the like. Using either modem 560 or network access card 550, the computer can be connected to either the finance company or the convenient payment receiving center via the Internet.

The network access card 550 can also be configured to exchange information with the web interface 170. The web interface 170 can either be a stand-alone module (as shown), or its function can be integrated into the automated code delivery computer 110 software and hardware, e.g., the processor 520. In addition, the modem 560 can be configured to exchange information with the telephony interface 180. Again, the telephony interface 180 can be a stand-alone module (as shown) or can be integrated into the automated code delivery computer 110.

When the web interface 170 and telephony interface 180 functions are integrated into the automated code delivery computer 110, the processor 520, in conjunction with memory 530, operates to perform the functions of determining whether an indication has been provided by the finance company that one or more payments have been received, determining the previous code released to the user and determining whether the payment verification indicates that more than one payment has been received. The processor 520 can be a microprocessor manufactured by companies such as Sun Microsystems, Intel or Advanced Microdevices. The storage device 540 stores the indications of payments received from the finance company and stores the codes which are released to the user. The storage device 540 can also store information to associate contract ID codes with stored codes and to store other information associated with releasing codes, such as email addresses of system users.

Although storage device 540 is illustrated as a single device located inside of the computer, it will be recognized that the storage device can be more than one device and that the storage device can be external to the computer. Although the automated code delivery computer is illustrated as including a monitor 510, keyboard 570 and mouse 580, it will be recognized that these are not required and may be omitted. For example, if the automated code delivery computer is setup as a server in a computer network the monitor 510, keyboard 570 and mouse 580 are not required for the proper functioning of the computer.

Although exemplary embodiments of the present invention have been described in connection with particular types of vehicle disablement devices, it will be recognized that the present invention is equally applicable to any type of vehicle disablement devices. Further, although exemplary embodiments of the present invention have been described in connection with a vehicle disablement device, it will be recognized that the present invention is equally applicable to any type of disablement device. Additionally, although exemplary embodiments of the present invention were described in connection with loan payments, the present invention is equally applicable to any other type of financing arrangements including leases and the like.

Although the present invention has been described in considerable detail with clear and concise language and with reference to certain exemplary embodiments thereof including the best mode anticipated by the inventors, other versions are possible. Therefore, the spirit and scope of the invention should not be limited by the description of the exemplary embodiments contained therein.

What is claimed is:

1. A method for obtaining a code and preventing disablement of a device comprising the steps of:
assigning a contract identification code associated with a loan contract;
a payment center receiving a loan payment;
forwarding the payment from the payment center to a finance company, wherein the finance company has an interest in the device;
a code delivery computer determining whether the finance company has received the payment;
the code delivery computer determining a previous code released for the device;
releasing a new code subsequent to the previous code released for the device if the code delivery computer determines that the finance company has received the payment;
the code delivery computer receiving the associated contract identification code from a user via telephony, an internet link, or an email;
the code delivery computer providing the new code directly to the user via telephony, an internet link, or an email;
the device receiving the code from the user, thereby preventing disablement of the device.

2. The method of claim 1, wherein the code delivery computer receives the associated contract identification code directly from the user.

3. The method of claim 1, wherein telephony is used to provide the associated contract identification code to the code delivery computer and to provide the new code directly to the user.

4. The method of claim 1, wherein the code delivery computer provides the new code directly to the user after receiving the associated contract identification code from the user.

5. The method of claim 1, wherein the internet link used to provide the associated contract identification code to the code delivery computer, and the internet link used to provide the new code directly to the user, are the same.

6. The method of claim 1, wherein the internet link includes a web page accessible via a web browser.

7. The method of claim 1, wherein the contract identification code is received and access to the released code is provided at the code delivery computer, via an internet interface.

8. The method of claim 1, wherein the contract identification code is received and access to the released code is provided at the code delivery computer, via a telephony interface.

9. The method of claim 1, wherein the device includes red, yellow and green lights which illuminate to indicate when a payment is due.

10. A system for providing a code and preventing disablement of a device comprising:
a device which receives codes to prevent disablement of the device;
a finance company, wherein the finance company has a security interest in the device and contracts for regular payments for the device;
a payment center for receiving payments for the device and for forwarding the payments to the finance company;
a code delivery computer which receives an indication from the finance company of whether a payment has been made and based on the indication provides codes directly to a user.

11. The system of claim 10, wherein the code delivery computer provides the codes to the user via an internet link.

12. The system of claim 10, wherein the code delivery computer provides the codes to the user via telephony.

13. The system of claim 10, wherein the code delivery computer provides the codes to the user via email.

14. The system of claim 10, wherein the device is a vehicle.

15. The system of claim 14, wherein the vehicle is an automobile.

16. The system of claim 10, wherein the payment center is an automated teller machine.

17. The system of claim 10, wherein the payment center is a financial institution.

18. The system of claim 10, wherein the payment center is a convenience store.

19. The system of claim 10, wherein the payment corresponds to a weekly, bi-weekly, semi-monthly, or monthly payment.

20. The system of claim 10, wherein the device includes red, yellow and green lights which illuminate to indicate when a payment is due.
